(19) United States
(12) Patent Application Publication
(10) Pub. No.: US 2008/0191960 A1
(43) Pub. Date: Aug. 14, 2008

(54) Portable antenna assembly

(75) Inventors: Chien-Chiung Wang, Tu-Cheng (TW); Hong-Feng Jiang, Kun-Shan (CN); Qing-Man Zhu, Kun-Shan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/069,370

(22) Filed: Feb. 7, 2008

(30) Foreign Application Priority Data
Feb. 9, 2007 (CN) 200710019753.7

(51) Int. Cl. H01Q 3/02

(52) U.S. Cl. 343/882

(57) ABSTRACT

An antenna assembly (100) includes a seat (20) defining a receiving space (12) and a pair of first bores, and an antenna element (10). The antenna element has a connecting portion (101) received in the receiving space, an antenna and a pivot axle (51) rotatably received in the first bores. The seat has a base (2) and a cover portion (1) rotatably engaging the seat.

### BACKGROUND OF THE INVENTION

1. Field of the Invention

The present invention relates in general to a portable antenna assembly, and more particularly to a portable antenna assembly having a rotatable antenna.

2. Description of Related Arts

TW Patent No. M255521, issued on Jan. 11, 2005, discloses a conventional antenna assembly including a seat secured to an electronic equipment, a connecting portion rotatably received in the seat, and an antenna secured to the seat with a pivot pin. The antenna can rotate in limited angles for receiving signals. However, the seat of the antenna assembly is secured to a fixed place or plane on the electronic equipment. That is, it is difficult to adjust the antenna in a suitable direction/location for receiving and transmitting signals.

Hence, it is desirable to provide a portable antenna assembly for receiving/transmitting signals in different angles.

### SUMMARY OF THE INVENTION

An object of the present invention is to provide a portable antenna assembly having improved seat that can be located in different ways for easily receiving and transmitting signals in different angles.

To achieve the above object, a portable antenna assembly comprises a seat defining a receiving space and a pair of first bores. The antenna element includes a connecting portion received in the receiving space, an antenna extending from the connecting portion, and a pivot axle rotatably received in the first bores. The seat comprises a base and a cover portion rotatably engaging with the seat.

In use, the cover portion is rotated in a certain degree. The cover portion and a front wall of the seat are adapted for supporting the antenna assembly. The antenna could rotate in a horizontally position or any other positions for receiving and transmitting signals. That is, it is easy to adjust a suitable direction/location of the antenna for receiving and transmitting signals.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of a portable antenna assembly of the present invention which is used in a first state;

FIG. 2 is a partially exploded perspective view of the antenna assembly as shown in FIG. 1;

FIG. 3 is an exploded view of a seat of the antenna assembly as shown in FIG. 2;

FIG. 4 is a perspective view of an upper base of the seat as shown in FIG. 3, taken from another aspect.

FIG. 5 is a view of a lower base of the seat as shown in FIG. 3, taken from another aspect;

FIG. 6 is a view similar to FIG. 5, taken from another aspect;

FIG. 7 is a view showing that the upper base is mounted to a cover portion of the seat; and

FIG. 8 is an assembled view of the antenna assembly used in a second state.

### DETAILED DESCRIPTION OF THE PREFERRED EMBODIMENT

Reference will now be made in detail to a preferred embodiment of the present invention.

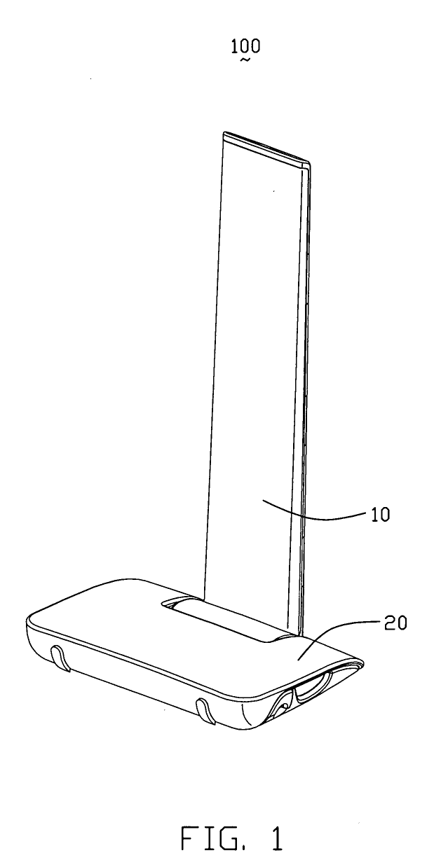

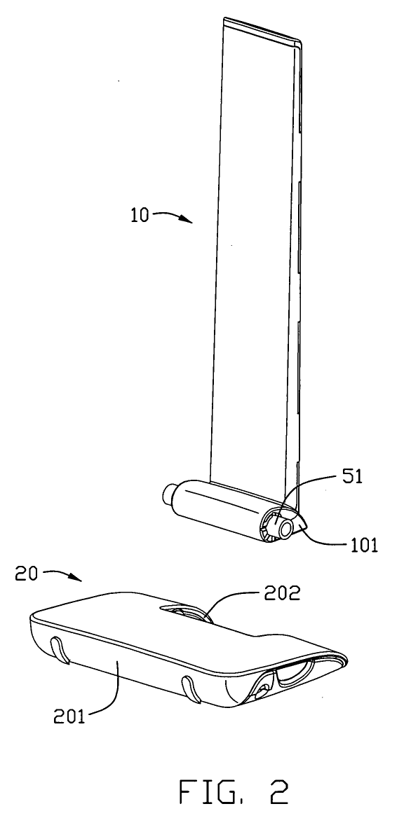

Referring to FIGS. 1 and 2, an portable antenna assembly 100 in accordance with a preferred embodiment of the present invention for receiving and transmitting signals comprises a seat 20 having a receiving space 12 defined at side edge thereof, and an antenna element 10 including a connecting portion 101 received in the receiving space 12 and an antenna (not labeled) extending from the connecting portion 101. The connecting portion 101 further has a pivot axle 51 including first pivot axle and second pivot axle respectively extending from opposite sides of connecting portion and rotated in corresponding first bores (not labeled) defined in the seat 20.

Referring to FIGS. 2, 3 and 8, the seat 20 comprises a front wall 201, a rear wall 202, a base 2 and a cover portion 1. The cover portion 1 covers the base 2 and rotatably engages with the rear wall 202 of the seat 20.

The cover portion 1 comprises a mating wall 140 extending downwardly and inwardly from a front side thereof, a pair of first projecting portions 15 extending downwardly from a rear portion thereof and a receiving room 141 defined between the mating wall 140 and the first projecting portions 15 for receiving the base 2. The cover portion 1 further comprises a first bulge 13 formed at an arced inner surface of the first projecting portion 15, toward the seat 20. The first bulge 13 has a rib 132 disposed thereon and a first hole 131 defined therethrough for coupling with a positioning pin 4. The mating wall 140 has a pair of cushions 14 disposed thereon.

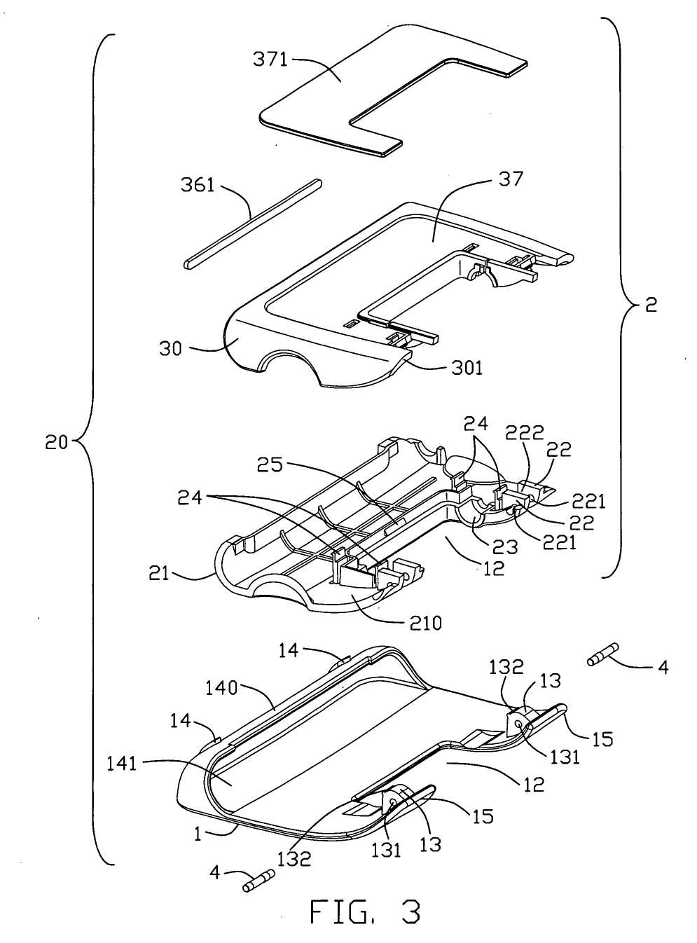

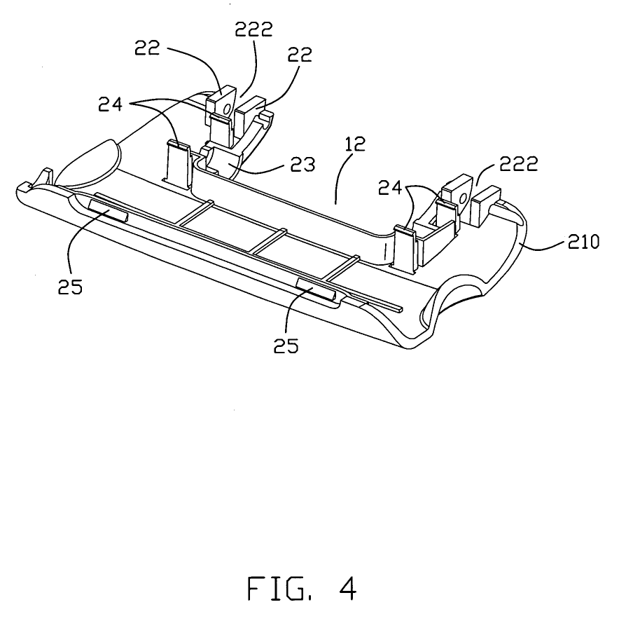

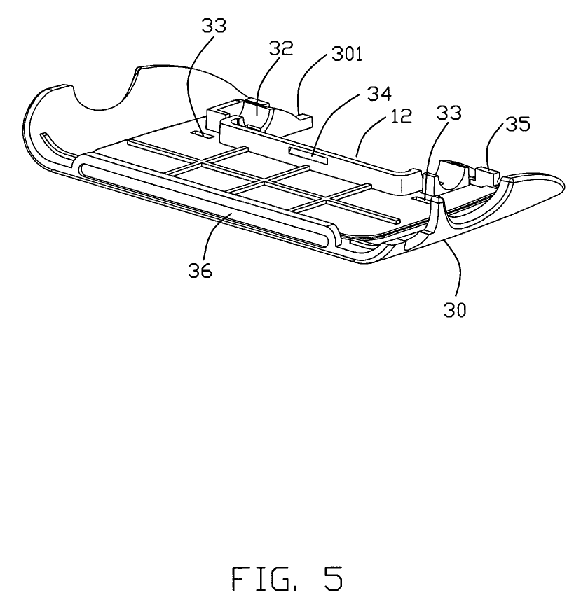

The base 2 has an upper base 21 and a lower base 30. Referring to FIGS. 3 and 4, the upper base 21 includes a pair of second projecting portions 210 extending rearwardly therefrom. Each second projecting portion 210 has a pair of opposite second bulges 22 formed at an arced inner surface of the second projecting portion 210 and an indentation 222 defined therebetween for receiving the first bulge 13 of the cover portion 1. Each second bulges 22 has a second hole 221 for coupling with the rib 132. The upper base 21 has a pair of first semicircular rooms 23 defined at opposite side portions thereof and the lower base 30 has a pair of corresponding second semicircular rooms 32 defined at the side edges thereof. The first and the second semicircular rooms 23, 32 together form the first bore of seat 20. Referring to FIGS. 3 and 5, the upper base 21 further has a plurality of cams 25 formed on the rear wall thereof for coupling with the corresponding first hollows 34 defined on the lower base 30. A plurality of locking portions 24 are disposed on an inner surface of the upper base 21 and extending toward the lower base 30 for firmly locking upper base 21 to the lower base 30. The seat 20 further has a second cushions 371 attached to a bottom surface of the lower base 30 for locating the antenna assembly on corresponding equipments (not shown) and a rubber strip 361 coupling with a gap 36 defined on an edge portion of the lower base 30.

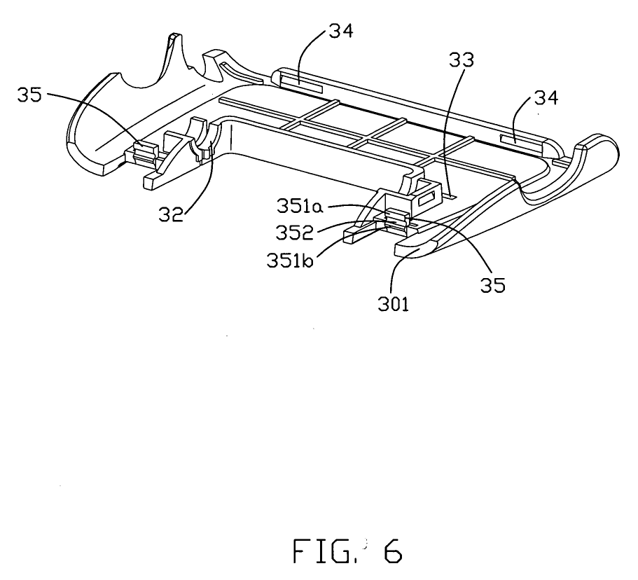

Referring to FIGS. 3, 5 and 6, the lower base 30 has a pair of third projecting portions 301 extending rearwardly and engaging with the second projecting portions 210. The third projecting portion 301 includes a pair of protruding portions 35 projecting from an inner surface of the lower base 30, toward the upper base 21. Each protruding portion 35 has a pair of second ribs 351a and 351b parallelly disposed thereon and a mating passage 352 formed between the second ribs 351a and 351b for engaging with the rib 132 of the cover portion 1. In use, the base 2 is absolutely covered by the cover portion 1, at this time, the rib 132 is located at a lower position of the second rib 352b. When the cover portion 1 rotates to an opening position, the rib 132 is received in the mating passage 352 for locating the cover portion 1.

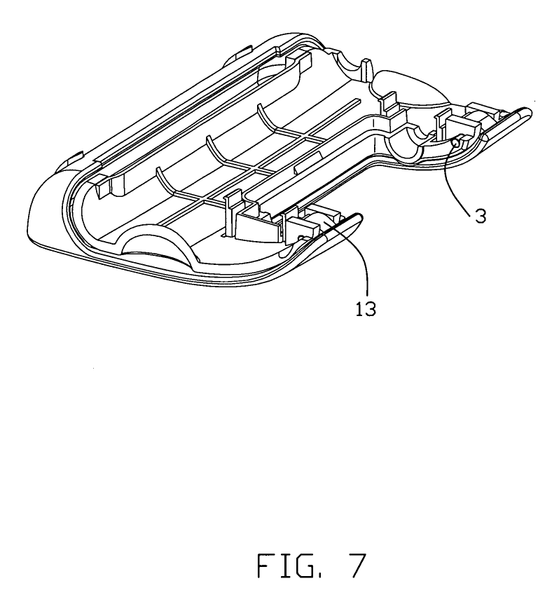

Referring to FIGS. 3, 6 and 7, in assembly, firstly, the first bulge 13 of the cover portion 1 is mounted in the indentation 222 of the upper base 21. The upper base 21 is received in the receiving room 141. The positioning pins 4 are received in both of the first holes 131 of the first bulges 13 and the second holes 221 of second bulges 22. Secondly, the connecting portion 101 of the antenna element 10 is located at the semicircular rooms 23 of the upper base 21. Finally, the lower base 30 is assembled to the upper base 21. The cams 25 couple with the corresponding first hollows 34 of the lower base 30. The locking portions 24 of the upper base 21 engage with the second hollows 33 defined on the lower base 30 for firmly locking upper base 21 to the lower base 30.

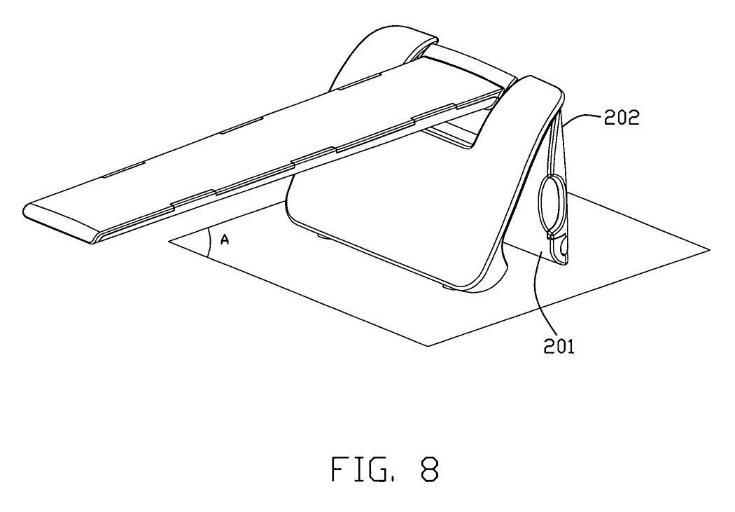

In use, the cover portion 1 is rotated in a certain degree as shown in FIG. 8. The mating wall 140 of the cover portion 1 and the front wall 201 of the seat 20 are adapted for supporting the antenna assembly 100. The antenna could rotate in a horizontally position and any other position for receiving and transmitting signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable antenna assembly adapted for receiving and transmitting signals, comprising:
a seat defining a receiving space and a pair of first bores, the seat comprising a base and a cover portion rotatably engaging with the base; and
an antenna element comprising a connecting portion received in the receiving space, an antenna extending from the connecting portion, and a pivot axle rotatably received in the first bores.

2. The antenna assembly as claimed in claim 1, wherein said cover portion comprises a mating wall extending downwardly from a front side thereof.

3. The antenna assembly as claimed in claim 1, wherein said base has an upper base and a lower base coupling with the upper base.

4. The antenna assembly as claimed in claim 3, wherein said upper base has a plurality of locking portions projecting toward the lower base, and the lower base has holes engaged with the locking portions.

5. The antenna assembly as claimed in claim 3, wherein said cover portion has a pair of first projecting portions extending rearwardly therefrom and the upper base has corresponding second projecting portions coupling with the first projecting portions.

6. The antenna assembly as claimed in claim 5, wherein each first projecting portion comprises a first bulge formed at an arced inner surface thereof toward the base.

7. The antenna assembly as claimed in claim 6, wherein each second projecting portion of the upper base has a pair of opposite second bulges formed at an arced inner surface thereof and an indentation defined between the opposite second bulges for receiving the first bulge of the cover portion.

8. The antenna assembly as claimed in claim 7, further comprising a positioning pin, and wherein the first and the second bulges respectively has a first and a second hole defined therethrough for receiving the positioning pin.

9. The antenna assembly as claimed in claim 5, wherein said lower base has a pair of third projecting portions extending rearwardly and engaging with the second projecting portion.

10. The antenna assembly as claimed in claim 9, wherein said third projecting portion provides a pair of protruding portions projecting from an inner surface of the lower base toward the upper base.

11. The antenna assembly as claimed in claim 10, wherein said protruding portion comprises a pair of second ribs parallelly disposed thereon and forming a mating passage, said first bulge of the cover portion having a rib for engaging with the mating passage.

12. The antenna assembly as claimed in claim 1, wherein said pivot axle of the antenna element has a first pivot axle and a second pivot axle respectively extending from opposite sides of connecting portion.

13. A portable antenna assembly adapted for receiving and transmitting signals, comprising:
a seat comprising a base and a cover portion rotatably engaging with the base about a pivot region so as to allow distal outer edges of the base and the cover spaced from each other and an intersecting angle defined between the base and the cover around the pivot region for supporting said seat to stand on a plane with the pivot region at an uppermost position of the whole seat; and
an antenna element pivotally connector around the pivot region and being allowed to be retained at a plurality of upward positions under a condition that said antenna element is essentially spaced from said plane with a distance defined by a longitudinal dimension of said seated along a direction defined between the pivot region and the outer edges.

14. The portable antenna assembly as claimed in claim 13, wherein said a pivot axis of the cover and the base is different from that of the seat and the antenna element.

15. The portable antenna assembly as claimed in claim 13, wherein a pivot axis of the seat and the antenna element is defined in said base.
